(19) United States
(12) Patent Application Publication
(10) Pub. No.: US 2015/0366195 A1
(43) Pub. Date: Dec. 24, 2015

(54) SYNTHETIC LIPOCHITOOLIGOSACCHARIDES FOR IMPROVEMENT OF PLANT GROWTH AND YIELD

(71) Applicants: PIONEER HI-BRED INTERNATIONAL, INC., Johnston,, IA (US); E. I. DUPONT DE NEMOURS & COMPANY, Wilmington,, DE (US)

(72) Inventors: Keith A. O'Bryan, Johnston, IA (US); France Rochette, Toronto (CA); SUBRAMANIAM SABESAN, WILMINGTON, DE (US)

(73) Assignee: Pioneer Hi-Bred International, Inc., Johnston, IA (US)

(21) Appl. No.: 14/763,937

(22) PCT Filed: Jan. 29, 2014
(86) PCT No.: PCT/US14/13638

§ 371 Date: Jul. 28, 2015

Related U.S. Application Data
(60) Provisional application No. 61/759,028, filed on Jan. 31, 2013.

(51) Int. Cl. A01N 43/16

(52) U.S. Cl. CPC A01N 43/16

(57) ABSTRACT

The invention provides formulations and methods for improving plant growth and crop yield. More specifically, the present invention relates to compositions comprising the synthetic LCO compound tetra-N-acyl-beta-D-methyl-glycoside (TAMG) and the related compounds of Formula I. TAMG may be applied to plant propagating materials, including seeds and other regenerable plant parts, including cuttings, bulbs, rhizomes and tubers. TAMG may also be applied to foliage, or soil either prior to or following planting of plant propagating materials. Such applications may be made alone or in combination with fungicides, insecticides, nematicides and other agricultural agents used to improve plant growth and crop yield. TAMG can improve the agronomic performance of a variety of crops including barley, canola, corn, potato, soybean and wheat.

### FIELD OF THE INVENTION

The present invention relates to formulations and methods of use of a synthetic lipochitooligosaccharide compound for improving plant growth and crop yield.

### BACKGROUND

Lipochitooligosaccharides (LCO's) are signaling molecules produced by rhizobia, which include various nitrogen-fixing bacteria that initiate early stage root nodulation in leguminous plants. The resulting symbiotic relationship between the bacteria and plant provides reduced nitrogen to the plant and enhances growth or yield. Both LCO's and rhizobial inoculants are used to increase the productivity of a variety of leguminous crops, including soybeans, peanuts, alfalfa, and dry beans. LCO's are also used to increase growth and yield in in non-leguminous crops such as corn.

Rhizobial inoculants and LCO's are currently produced via fermentation. The use of rhizobial inoculants, however, is constrained by several factors, including variability in production and cell viability in commercial formulations. Likewise, individual LCO's may be difficult to isolate from mixtures or are not amenable to economical methods of synthesis. Thus, there remains a need for a cost-effective alternative to biologically produced LCO's with comparable growth or yield enhancing activity for agricultural applications. The present invention addresses this need.

### SUMMARY OF THE INVENTION

The invention provides formulations and methods for improving plant growth and crop yield. More specifically, the present invention relates to compositions comprising the synthetic LCO compound tetra-N-acyl-beta-D-methyl-glycoside (TAMG) and the related compounds of Formula I. TAMG may be applied to plant propagating materials, including seeds and other regenerable plant parts, including cuttings, bulbs, rhizomes and tubers. TAMG may also be applied to foliage, or soil either prior to or following planting of plant propagating materials. Such applications may be made alone or in combination with fungicides, insecticides, nematicides and other agricultural agents used to improve plant growth and crop yield. TAMG can improve the agronomic performance of a variety of crops including barley, canola, corn, potato, soybean and wheat.

### DETAILED DESCRIPTION OF THE INVENTION

The invention provides formulations and methods for improving plant growth and crop yield by treating plant propagating materials, foliage or soil with biologically effective amounts of the compounds of Formula I herein below:

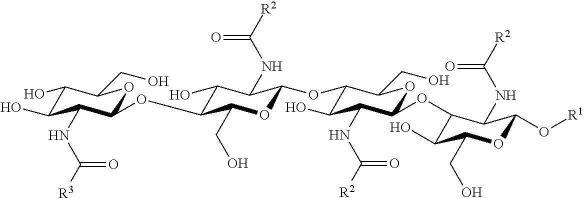

where individual groups R¹ and R² are independently selected from: H, C₁ to C₂₀ alkyl, aryl, and aralkyl; and C₂ to C₂₀ mono, di or polyalkynyl groups; R³ is selected from C₁ to C₂₀ alkyl, aryl, and aralkyl; and C₂ to C₂₀ mono, di or polyalkynyl groups.

In a preferred embodiment the present invention relates to compositions comprising the synthetic LCO compound tetra-N-acyl-beta-D-methyl-glycoside (TAMG) shown below:

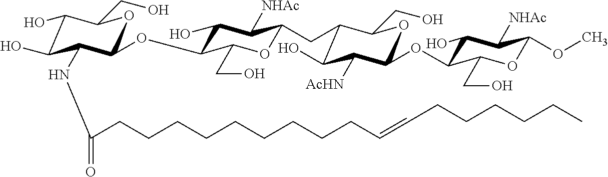

Methods for synthesis of the compounds of Formula I are described in U.S. Pat. No. 8,049,002.

The term “agricultural composition” as used herein comprises one or more substances formulated for at least one agricultural application. Agricultural applications are understood to include, but not be limited to, yield improvement, pest control, disease control and resistance to abiotic environmental stress.

As used herein the term “biologically effective amount” refers to that amount of a substance required to produce the desired effect on plant growth and yield. Effective amounts of the composition will depend on several factors, including treatment method, plant species, propagating material type and environmental conditions.

Foliage as defined in the present application includes all aerial plant organs, that is, the leaves, stems, flowers and fruit.

As used herein, “germination percentage” or “germination rate” refers the percentage of seeds that germinate after planting or being placed under conditions otherwise suitable for germination. The term “acceleration of germination” and its equivalents refer to an increase in the percent germination of experimentally treated seeds compared to seeds designated as experimental controls as a function of time, generally expressed as days after planting (DAP). In the Examples presented herein, seed germination rates were determined with laboratory-based germination assays conducted under optimum conditions for germination and conditions simulating salt and cold stress, wherein germination percentages were determined at specified DAP. General descriptions of seed germination tests can be found in the Handbook of Seed Technology for Genebanks, Volume I. Principles and Methodology, R. H. Ellis, T. D. Hong and E. H. Roberts, Eds., International Board for Plant Genetic resources, Rome, 1985, pp. 94-120 and the Seed Vigor Testing Handbook, Contribution No. 32 to the Handbook on Seed Testing prepared by the Seed Vigor Test Committee of the Association of Official Seed Analysts, 1983. Examples of seed cold and salt stress germination assays are respectively described in Burris and Navratil, Agronomy Journal, 71: 985-988 (1979) and Scialabba, et al., Seed Science & Technology, 27: 865-870 (1999).

Plant “growth” as used herein is defined by, but not limited to, measurements of seedling emergence, early growth, plant height, time to flowering, tillering (for grasses), days to maturity, vigor, biomass and yield.

As referred to in the present disclosure and claims, the term “propagating material” means a seed or regenerable plant part. The term “regenerable plant part” means a part of the plant other than a seed from which a whole plant may be grown or regenerated when the plant part is placed in agricultural or horticultural growing media such as moistened soil, peat moss, sand, vermiculite, perlite, rock wool, fiberglass, coconut husk fiber, tree fern fiber, and the like, or even a completely liquid medium such as water. Regenerable plant parts commonly include rhizomes, tubers, bulbs and corms of such geophytic plant species as potato, sweet potato, yam, onion, dahlia, tulip, narcissus, etc. Regenerable plant parts include plant parts that are divided (e.g., cut) to preserve their ability to grow into a new plant. Therefore regenerable plant parts include viable divisions of rhizomes, tubers, bulbs and corms which retain meristematic tissue, such as an eye. Regenerable plant parts can also include other plant parts such as cut or separated stems and leaves from which some species of plants can be grown using horticultural or agricultural growing media. As referred to in the present disclosure and claims, unless otherwise indicated, the term “seed” includes both unsprouted seeds and seeds in which the testa (seed coat) still surrounds part of the emerging shoot and root.

The term “rhizosphere” as defined herein refers to the area of soil that immediately surrounds and is affected by the plant's roots.

As used herein, the term “treating” means applying a biologically effective amount of TAGM, or a composition containing TAGM, to a seed or other plant propagating material, plant foliage or plant rhizosphere; related terms such as “treatment” are defined analogously.

As used herein, the terms “vigor” or “crop vigor” refer to the rate of growth, biomass volume, ground cover or foliage volume of a crop plant. In the Examples presented herein, “vigor” was determined by visual assessment and comparative scoring of plant growth parameters including height, width, and ground cover compared to control treatments.

The term “yield” as defined herein refers to the return of crop material per unit area obtained after harvesting a plant crop. An increase in crop yield refers to an increase in crop yield relative to an untreated control treatment. Crop materials include, but are not limited to, seeds, fruits, roots, tubers, leaves and types of crop biomass. Descriptions of field-plot techniques used to evaluate crop yield may be found in W. R. Fehr, Principles of Cultivar Development, McGraw-Hill, Inc., New York, NE, 1987, pp. 261-286 and references incorporated therein.

In one embodiment of the invention, the composition is applied as a seed treatment formulation. Such formulations typically contain from about 10⁻⁵ M to 10⁻¹² M of the composition. In a preferred embodiment, formulations contain from about 10⁻⁶ M to 10⁻¹⁰ M of a Formula I compound. The locus of the propagating materials can be treated with a Formula I compound by many different methods. All that is needed is for a biologically effective amount of a Formula I compound to be applied on or sufficiently close to the propagating material so that it can be absorbed by the propagating material. The Formula I compound can be applied by such methods as drenching the growing medium including a propagating material with a solution or dispersion of a Formula I compound, mixing a Formula I compound with growing medium and planting a propagating material in the treated growing medium (e.g., nursery box treatments), or various forms of propagating material treatments whereby a Formula I compound is applied to a propagating material before it is planted in a growing medium.

In these methods a Formula I compound will generally be used as a formulation or composition with an agriculturally suitable carrier comprising at least one of a liquid diluent, a solid diluent or a surfactant. A wide variety of formulations are suitable for this invention, the most suitable types of formulations depend upon the method of application. As is well known to those skilled in the art, the purpose of formulation is to provide a safe and convenient means of transporting, measuring and dispensing the agricultural agent and also to optimize its efficacy.

Depending on the method of application useful formulations include liquids such as solutions (including emulsifiable concentrates), suspensions, emulsions (including microemulsions and/or suspoemulsions) and the like which optionally can be thickened into gels. Useful formulations further include solids such as dusts, powders, granules, pellets, tablets, films, and the like which can be water-dispersible (“wettable”) or water-soluble. Active ingredient can be (micro)encapsulated and further formed into a suspension or solid formulation; alternatively the entire formulation of active ingredient can be encapsulated (or “overcoated”). Encapsulation can control or delay release of the active ingredient. Sprayable formulations can be extended in suitable media and used at spray volumes from about one to several hundred liters per hectare. High-strength compositions are primarily used as intermediates for further formulation.

The formulations will typically contain effective amounts of active ingredient, diluent and surfactant within the following approximate ranges that add up to 100 percent by weight.

| | Weight Percent | | |
|---|---|---|---|
| | Active Ingredient | Diluent | Surfactant |
| Water-Dispersible and | 5-90 | 0-94 | 1-15 |
| Water-soluble Granules, | | | |
| Tablets and Powders. | | | |
| Suspensions, Emulsions, | 5-50 | 40-95 | 0-15 |
| Solutions (including | | | |
| Emulsifiable Concentrates) | | | |
| Dusts | 1-25 | 70-99 | 0-5 |
| Granules and Pellets | 0.01-99 | 5-99.99 | 0-15 |
| High Strength | 90-99 | 0-10 | 0-2 |
| Compositions | | | |

Typical solid diluents are described in Watkins et al., Handbook of Insecticide Dust Diluents and Carriers, 2nd Ed., Dorland Books, Caldwell, N.J. Typical liquid diluents are described in Marsden, Solvents Guide, 2nd Ed., Interscience, New York, 1950. McCutcheon's Emulsifiers and Detergents and McCutcheon's Functional Materials (North America and International Editions, 2001), The Manufacturing Confection Publ. Co., Glen Rock, N.J., as well as Sisely and Wood, Encyclopedia of Surface Active Agents, Chemical Publ. Co., Inc., New York, 1964, list surfactants and recommended uses. All formulations can contain minor amounts of additives to reduce foam, caking, corrosion, microbiological growth and the like, or thickeners to increase viscosity.

Surfactants include, for example, ethoxylated alcohols, ethoxylated alkylphenols, ethoxylated sorbitan fatty acid esters, ethoxylated amines, ethoxylated fatty acids, esters and oils, dialkyl sulfosuccinates, alkyl sulfates, alkylaryl sulfonates, organosilicones, N,N-dialkyltaurates, glycol esters, phosphate esters, lignin sulfonates, naphthalene sulfonate formaldehyde condensates, polycarboxylates, and block polymers including polyoxyethylene/polyoxypropylene block copolymers.

Solid diluents include, for example, clays such as bentonite, montmorillonite, attapulgite and kaolin, starch, sugar, silica, talc, diatomaceous earth, urea, calcium carbonate, sodium carbonate and bicarbonate, and sodium sulfate. Liquid diluents include, for example, water, N,N-dimethylformamide, dimethyl sulfoxide, N-alkylpyrrolidone, ethylene glycol, polypropylene glycol, propylene carbonate, dibasic esters, paraffins, alkylbenzenes, alkylnaphthalenes, oils of olive, castor, linseed, tung, sesame, corn, peanut, cotton-seed, soybean, rape-seed and coconut, fatty acid esters, ketones such as cyclohexanone, 2-heptanone, isophorone and 4-hydroxy-4-methyl-2-pentanone, and alcohols such as methanol, cyclohexanol, decanol, benzyl and tetrahydrofurfuryl alcohol.

Solutions, including emulsifiable concentrates, can be prepared by simply mixing the ingredients. Dusts and powders can be prepared by blending and, usually, grinding as in a hammer mill or fluid-energy mill. Suspensions are usually prepared by wet-milling; see, for example, U.S. Pat. No. 3,060,084. Granules and pellets can be prepared by spraying the active material upon preformed granular carriers or by agglomeration techniques. See Browning, “Agglomeration”, Chemical Engineering, Dec. 4, 1967, pp. 147-48, Perry's Chemical Engineer's Handbook, 4th Ed., McGraw-Hill, New York, 1963, pp. 8-57 and following, and PCT Publication WO 91/13546. Pellets can be prepared as described in U.S. Pat. No. 4,172,714. Water-dispersible and water-soluble granules can be prepared as taught in U.S. Pat. No. 4,144,050, U.S. Pat. No. 3,920,442 and DE 3,246,493. Tablets can be prepared as taught in U.S. Pat. No. 5,180,587, U.S. Pat. No. 5,232,701 and U.S. Pat. No. 5,208,030. Films can be prepared as taught in GB 2,095,558 and U.S. Pat. No. 3,299,566.

For further information regarding the art of formulation, see T. S. Woods, “The Formulator's Toolbox—Product Forms for Modern Agriculture” in Pesticide Chemistry and Bioscience, The Food-Environment Challenge, T. Brooks and T. R. Roberts, Eds., Proceedings of the 9th International Congress on Pesticide Chemistry, The Royal Society of Chemistry, Cambridge, 1999, pp. 120-133. See also U.S. Pat. No. 3,235,361, Col. 6, line 16 through Col. 7, line 19 and Examples 10-41; U.S. Pat. No. 3,309,192, Col. 5, line 43 through Col. 7, line 62 and Examples 8, 12, 15, 39, 41, 52, 53, 58, 132, 138-140, 162-164, 166, 167 and 169-182; U.S. Pat. No. 2,891,855, Col. 3, line 66 through Col. 5, line 17 and Examples 1-4; Klingman, Weed Control as a Science, John Wiley and Sons, Inc., New York, 1961, pp 81-96; and Hance et al., Weed Control Handbook, 8th Ed., Blackwell Scientific Publications, Oxford, 1989.

The compositions used for treating propagating materials, or plants grown therefrom, according to this invention can also comprise (besides the Formula I component) an effective amount of one or more other biologically active compounds or agents. Suitable additional compounds or agents include, but are not limited to, insecticides, fungicides, nematocides, bactericides, acaricides, entomopathogenic bacteria, viruses or fungi, growth regulators such as rooting stimulants, chemosterilants, repellents, attractants, pheromones, feeding stimulants and other signal compounds including apocarotenoids, flavonoids, jasmonates and strigolactones (Akiyama, et al., in Nature, 435:824-827 (2005); Harrison, in Ann. Rev. Microbiol., 59:19-42 (2005); Besserer, et al., in PLoS Biol., 4(7):e226 (2006); WO2009049747). These compounds can be formulated into a multi-component pesticide giving an even broader spectrum of agricultural utility than can be achieved with the Formula I component alone.

Examples of such biologically active compounds or agents with which compounds of this invention can be formulated are: insecticides such as abamectin, acephate, acetamiprid, amidoflumet (S-1955), avermectin, azadirachtin, azinphos-methyl, bifenthrin, binfenazate, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenproximate, fenvalerate, fipronil, flonicamid, flucythrinate, tau-fluvalinate, flufenerim (UR-50701), flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, noviflumuron (XDE-007), oxamyl, parathion, parathion-methyl, permethrin, phorate, phosalone, phosmet, phosphamidon, pirimicarb, profenofos, pymetrozine, pyridalyl, pyriproxyfen, rotenone, spinosad, spiromesifin (BSN 2060), sulprofos, tebufenozide, teflubenzuron, tefluthrin, terbufos, tetrachlorvinphos, thiacloprid, thiamethoxam, thiodicarb, thiosultap-sodium, tralomethrin, trichlorfon and triflumuron; fungicides such as acibenzolar, azoxystrobin, benomyl, blasticidin-S, Bordeaux mixture (tribasic copper sulfate), bromuconazole, carpropamid, captafol, captan, carbendazim, chloroneb, chlorothalonil, copper oxychloride, copper salts, cyflufenamid, cymoxanil, cyproconazole, cyprodinil, (S)-3,5-dichloro-N-(3-chloro-1-ethyl-1-methyl-2-oxopropyl)-4-methylbenzamide (RH 7281), diclocymet (S-2900), diclomezine, dicloran, difenoconazole, (S)-3,5-dihydro-5-methyl-2-(methylthio)-5-phenyl-3-(phenylamino)-4H-imidazol-4-one (RP 407213), dimethomorph, dimoxystrobin, diniconazole, diniconazole-M, dodine, edifenphos, epoxiconazole, famoxadone, fenamidone, fenarimol, fenbuconazole, fencaramid (SZX0722), fenpiclonil, fenpropidin, fenpropimorph, fentin acetate, fentin hydroxide, fluazinam, fludioxonil, flumetover (RPA 403397), flumorf/flumorlin (SYP-L190), fluoxastrobin (HEC 5725), fluquinconazole, flusilazole, flutolanil, flutriafol, folpet, fosetyl-aluminum, furalaxyl, furametapyr (S-82658), hexaconazole, ipconazole, iprobenfos, iprodione, isoprothiolane, kasugamycin, kresoxim-methyl, mancozeb, maneb, mefenoxam, mepronil, metalaxyl, metconazole, metominostrobin/fenominostrobin (SSF-126), metrafenone (AC 375839), myclobutanil, neo-asozin (ferric methanearsonate), nicobifen (BAS 510), orysastrobin, oxadixyl, penconazole, pencycuron, probenazole, prochloraz, propamocarb, propiconazole, proquinazid (DPX-KQ926), prothioconazole (JAU 6476), pyrifenox, pyraclostrobin, pyrimethanil, pyroquilon, quinoxyfen, spiroxamine, sulfur, tebuconazole, tetraconazole, thiabendazole, thifluzamide, thiophanate-methyl, thiram, tiadinil, triadimefon, triadimenol, tricyclazole, trifloxystrobin, triticonazole, validamycin and vinclozolin; nematocides such as aldicarb, oxamyl and fenamiphos; bactericides such as streptomycin; acaricides such as amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben and tebufenpyrad; and biological agents including Bacillus thuringiensis (including ssp. aizawai and kurstaki), Bacillus thuringiensis delta-endotoxin, baculoviruses, and entomopathogenic bacteria, viruses and fungi. A general reference for these agricultural protectants is The Pesticide Manual, 12th Edition, C. D. S. Tomlin, Ed., British Crop Protection Council, Farnham, Surrey, U. K., 2000.

Preferred insecticides and acaricides for mixing with Formula I compounds include pyrethroids such as cypermethrin, cyhalothrin, cyfluthrin and beta-cyfluthrin, esfenvalerate, fenvalerate and tralomethrin; carbamates such as fenothicarb, methomyl, oxamyl and thiodicarb; neonicotinoids such as clothianidin, imidacloprid and thiacloprid; neuronal sodium channel blockers such as indoxacarb, insecticidal macrocyclic lactones such as spinosad, abamectin, avermectin and emamectin; γ-aminobutyric acid (GABA) antagonists such as endosulfan, ethiprole and fipronil; insecticidal ureas such as flufenoxuron and triflumuron; juvenile hormone mimics such as diofenolan and pyriproxyfen; pymetrozine; and amitraz. Preferred biological agents for mixing with compounds of this invention include Bacillus thuringiensis and Bacillus thuringiensis delta-endotoxin as well as naturally occurring and genetically modified viral insecticides including members of the family Baculoviridae as well as entomophagous fungi.

Preferred plant growth regulators for mixing with the Formula I compounds in compositions for treating stem cuttings are 1H-indole-3-acetic acid, 1H-indole-3-butanoic acid and 1-naphthaleneacetic acid and their agriculturally suitable salt, ester and amide derivatives, such as 1-napthaleneacetamide. Preferred fungicides for mixing with the Formula I compounds include fungicides useful as seed treatments such as thiram, maneb, mancozeb and captan.

For growing-medium drenches, the formulation needs to provide the Formula I compound, generally after dilution with water, in solution or as particles small enough to remain dispersed in the liquid. Water-dispersible or soluble powders, granules, tablets, emulsifiable concentrates, aqueous suspension concentrates and the like are formulations suitable for aqueous drenches of growing media. Drenches are most satisfactory for treating growing media that have relatively high porosity, such as light soils or artificial growing medium comprising porous materials such as peat moss, perlite, vermiculite and the like. The drench liquid comprising the Formula I compound can also be added to a liquid growing medium (i.e. hydroponics), which causes the Formula I compound to become part of the liquid growing medium. One skilled the art will appreciate that the amount of Formula I compound needed in the drench liquid for efficacy (i.e. biologically effective amount) will vary with several factors including, but not limited to, plant species, propagating material type and environmental conditions. The concentration of Formula I compound in the drench liquid is generally between about 10⁻⁵ M to 10⁻¹² M of the composition, more typically between about 10⁻⁶ M to 10⁻¹⁰ M. One skilled in the art can easily determine the biologically effective concentration necessary for the desired level of efficacy.

For treating a growing medium a Formula I compound can also be applied by mixing it as a dry powder or granule formulation with the growing medium. Because this method of application does not require first dispersing or dissolving in water, the dry powder or granule formulations need not be highly dispersible or soluble. While in a nursery box the entire body of growing medium may be treated, in an agricultural field only the soil in the vicinity of the propagating material is typically treated for environmental and cost reasons. To minimize application effort and expense, a formulation of Formula I compound is most efficiently applied concurrently with propagating material planting (e.g., seeding). For in-furrow application, the Formula I formulation (most conveniently a granule formulation) is applied directly behind the planter shoe. For T-band application, the Formula I formulation is applied in a band over the row behind the planter shoe and behind or usually in front of the press wheel. One skilled the art will appreciate that the amount of Formula I compound needed in the growing medium locus for efficacy (i.e. biologically effective amount) will vary with several factors including, but not limited to, plant species, propagating material type and environmental conditions. The concentration of Formula I compound in the growing medium locus is generally between about 10⁻⁵ M to 10⁻¹² M of the composition, more typically between about 10⁻⁶ M to 10⁻¹⁰ M. One skilled in the art can easily determine the biologically effective amount necessary for the desired level efficacy.

A propagating material can be directly treated by soaking it in a solution or dispersion of a Formula I compound. Although this application method is useful for propagating materials of all types, treatment of large seeds (e.g., having a mean diameter of at least 3 mm) is more effective than treatment of small seeds for providing efficacy. Treatment of propagating materials such as tubers, bulbs, corms, rhizomes and stem and leaf cuttings also can provide effective treatment of the developing plant in addition to the propagating material. The formulations useful for growing-medium drenches are generally also useful for soaking treatments. The soaking medium comprises a nonphytotoxic liquid, generally water-based although it may contain nonphytotoxic amounts of other solvents such as methanol, ethanol, isopropanol, ethylene glycol, propylene glycol, propylene carbonate, benzyl alcohol, dibasic esters, acetone, methyl acetate, ethyl acetate, cyclohexanone, dimethylsulfoxide and N-methylpyrrolidone, which may be useful for enhancing solubility of the Formula I compound and penetration into the propagating material. A surfactant can facilitate wetting of the propagating material and penetration of the Formula I compound. One skilled the art will appreciate that the amount of Formula I compound needed in the soaking medium for efficacy (i.e. biologically effective amount) will vary with several factors including, but not limited to, plant species, propagating material type and environmental conditions. The concentration of Formula I compound in the soaking liquid is generally between about 10⁻⁶ M to 10⁻¹² M of the composition, more typically between about 10⁻⁶ M to 10⁻¹⁰ M. One skilled in the art can easily determine the biologically effective concentration necessary for the desired level of efficacy. The soaking time can vary from one minute to one day or even longer. Indeed, the propagating material can remain in the treatment liquid while it is germinating or sprouting (e.g., sprouting of rice seeds prior to direct seeding). As shoot and root emerge through the testa (seed coat), the shoot and root directly contact the solution comprising the Formula I compound. For treatment of sprouting seeds of large-seeded crops such as rice, treatment times of about 8 to 48 hours, e.g., about 24 hours, is typical. Shorter times are most useful for treating small seeds.

A propagating material can also be coated with a composition comprising a biologically effective amount of a Formula I compound. The coatings of the invention are capable of effecting a slow release of a Formula I compound by diffusion into the propagating material and surrounding medium. Coatings include dry dusts or powders adhering to the propagating material by action of a sticking agent such as methylcellulose or gum arabic. Coatings can also be prepared from suspension concentrates, water-dispersible powders or emulsions that are suspended in water, sprayed on the propagating material in a tumbling device and then dried. Formula I compounds that are dissolved in the solvent can be sprayed on the tumbling propagating material and the solvent then evaporated. Such compositions preferably include ingredients promoting adhesion of the coating to the propagating material. The compositions may also contain surfactants promoting wetting of the propagating material. Solvents used must not be phytotoxic to the propagating material; generally water is used, but other volatile solvents with low phytotoxicity such as methanol, ethanol, methyl acetate, ethyl acetate, acetone, etc. may be employed alone or in combination. Volatile solvents are those with a normal boiling point less than about 100° C. Drying must be conducted in a way not to injure the propagating material or induce premature germination or sprouting.

The thickness of coatings can vary from adhering dusts to thin films to pellet layers about 0.5 to 5 mm thick. Propagating material coatings of this invention can comprise more than one adhering layer, only one of which need comprise a Formula I compound. Generally pellets are most satisfactory for small seeds, because their ability to provide a biologically effective amount of a Formula I compound is not limited by the surface area of the seed, and pelleting small seeds also facilitates seed transfer and planting operations. Because of their larger size and surface area, large seeds and bulbs, tubers, corms and rhizomes and their viable cuttings are generally not pelleted, but instead coated with powders or thin films.

Propagating materials contacted with compounds of Formula I in accordance to this invention include seeds. Suitable seeds include seeds of wheat, durum wheat, barley, oat, rye, maize, sorghum, rice, wild rice, cotton, flax, sunflower, soybean, garden bean, lima bean, broad bean, garden pea, peanut, alfalfa, beet, garden lettuce, rapeseed, cole crop, turnip, leaf mustard, black mustard, tomato, potato, pepper, eggplant, tobacco, cucumber, muskmelon, watermelon, squash, carrot, zinnia, cosmos, chrysanthemum, sweet scabious, snapdragon, gerbera, babys-breath, statice, blazing star, lisianthus, yarrow, marigold, pansy, impatiens, petunia, geranium and coleus. Of note are seeds of cotton, maize, soybean and rice. Propagating materials contacted with compounds of Formula I in accordance to this invention also include rhizomes, tubers, bulbs or corms, or viable divisions thereof. Suitable rhizomes, tubers, bulbs and corms, or viable divisions thereof include those of potato, sweet potato, yam, garden onion, tulip, gladiolus, lily, narcissus, dahlia, iris, crocus, anemone, hyacinth, grape-hyacinth, freesia, ornamental onion, wood-sorrel, squill, cyclamen, glory-of-the-snow, striped squill, calla lily, gloxinia and tuberous begonia. Of note are rhizomes, tubers, bulbs and corms, or viable division thereof of potato, sweet potato, garden onion, tulip, daffodil, crocus and hyacinth. Propagating materials contacted with compounds of Formula I in accordance to this invention also include stems and leaf cuttings.

One embodiment of a propagating material contacted with a Formula I compound is a propagating material coated with a composition comprising a compound of Formula I and a film former or adhesive agent. Compositions of this invention which comprise a biologically effective amount of a compound of Formula I and a film former or adhesive agent, can further comprise an effective amount of at least one additional biologically active compound or agent. Of note are compositions comprising (in addition to the Formula I component and the film former or adhesive agent) an arthropodicides of the group consisting of pyrethroids, carbamates, neonicotinoids, neuronal sodium channel blockers, insecticidal macrocyclic lactones, γ-aminobutyric acid (GABA) antagonists, insecticidal ureas and juvenile hormone mimics. Also of note are compositions comprising (in addition to the Formula I component and the film former or adhesive agent) at least one additional biologically active compound or agent selected from the group consisting of abamectin, acephate, acetamiprid, amidoflumet (S-1955), avermectin, azadirachtin, azinphos-methyl, bifenthrin, binfenazate, buprofezin, carbofuran, chlorfenapyr, chlorfluazuron, chlorpyrifos, chlorpyrifos-methyl, chromafenozide, clothianidin, cyfluthrin, beta-cyfluthrin, cyhalothrin, lambda-cyhalothrin, cypermethrin, cyromazine, deltamethrin, diafenthiuron, diazinon, diflubenzuron, dimethoate, diofenolan, emamectin, endosulfan, esfenvalerate, ethiprole, fenothicarb, fenoxycarb, fenpropathrin, fenproximate, fenvalerate, fipronil, flonicamid, flucythrinate, tau-fluvalinate, flufenerim (UR-50701), flufenoxuron, fonophos, halofenozide, hexaflumuron, imidacloprid, indoxacarb, isofenphos, lufenuron, malathion, metaldehyde, methamidophos, methidathion, methomyl, methoprene, methoxychlor, monocrotophos, methoxyfenozide, nithiazin, novaluron, noviflumuron (XDE-007), oxamyl, parathion, parathion-methyl, permethrin, phorate, phosalone, phosmet, phosphamidon, pirimicarb, profenofos, pymetrozine, pyridalyl, pyriproxyfen, rotenone, spinosad, spiromesifin (BSN 2060), sulprofos, tebufenozide, teflubenzuron, tefluthrin, terbufos, tetrachlorvinphos, thiacloprid, thiamethoxam, thiodicarb, thiosultap-sodium, tralomethrin, trichlorfon and triflumuron, aldicarb, oxamyl, fenamiphos, amitraz, chinomethionat, chlorobenzilate, cyhexatin, dicofol, dienochlor, etoxazole, fenazaquin, fenbutatin oxide, fenpropathrin, fenpyroximate, hexythiazox, propargite, pyridaben, tebufenpyrad; and biological agents such as Bacillus thuringiensis (including ssp. aizawai and kurstaki), Bacillus thuringiensis delta-endotoxin, baculoviruses, and entomopathogenic bacteria, viruses and fungi. Also of note are compositions comprising (in addition to the Formula I component and the film former or adhesive agent) at least one additional biologically active compound or agent selected from fungicides of the group consisting of acibenzolar, azoxystrobin, benomyl, blasticidin-S, Bordeaux mixture (tribasic copper sulfate), bromuconazole, carpropamid, captafol, captan, carbendazim, chloroneb, chlorothalonil, copper oxychloride, copper salts, cyflufenamid, cymoxanil, cyproconazole, cyprodinil, (S)-3,5-dichloro-N-(3-chloro-1-ethyl-1-methyl-2-oxopropyl)-4-methylbenzamide (RH 7281), diclocymet (S-2900), diclomezine, dicloran, difenoconazole, (S)-3,5-dihydro-5-methyl-2-(methylthio)-5-phenyl-3-(phenylamino)-4H-imidazol-4-one (RP 407213), dimethomorph, dimoxystrobin, diniconazole, diniconazole-M, dodine, edifenphos, epoxiconazole, famoxadone, fenamidone, fenarimol, fenbuconazole, fencaramid (SZX0722), fenpiclonil, fenpropidin, fenpropimorph, fentin acetate, fentin hydroxide, fluazinam, fludioxonil, flumetover (RPA 403397), flumorf/flumorlin (SYP-L190), fluoxastrobin (HEC 5725), fluquinconazole, flusilazole, flutolanil, flutriafol, folpet, fosetyl-aluminum, furalaxyl, furametapyr (S-82658), hexaconazole, ipconazole, iprobenfos, iprodione, isoprothiolane, kasugamycin, kresoxim-methyl, mancozeb, maneb, mefenoxam, mepronil, metalaxyl, metconazole, metominostrobin/fenominostrobin (SSF-126), metrafenone (AC 375839), myclobutanil, neo-asozin (ferric methanearsonate), nicobifen (BAS 510), orysastrobin, oxadixyl, penconazole, pencycuron, probenazole, prochloraz, propamocarb, propiconazole, proquinazid (DPX-KQ926), prothioconazole (JAU 6476), pyrifenox, pyraclostrobin, pyrimethanil, pyroquilon, quinoxyfen, spiroxamine, sulfur, tebuconazole, tetraconazole, thiabendazole, thifluzamide, thiophanate-methyl, thiram, tiadinil, triadimefon, triadimenol, tricyclazole, trifloxystrobin, triticonazole, validamycin and vinclozolin (especially compositions wherein the at least one additional biologically active compound or agent is selected from fungicides in the group consisting of thiram, maneb, mancozeb and captan).

Generally a propagating material coating of the invention comprises a compound of Formula I, a film former or sticking agent. The coating may further comprise formulation aids such as a dispersant, a surfactant, a carrier and optionally an antifoam and dye. One skilled the art will appreciate that the amount of Formula I compound needed for efficacy (i.e. biologically effective amount) will vary with several factors including, but not limited to, plant species, propagating material type and environmental conditions. The coating needs to not inhibit germination or sprouting of the propagating material.

The film former or adhesive agent component of the propagating material coating is composed preferably of an adhesive polymer that may be natural or synthetic and is without phytotoxic effect on the propagating material to be coated. The film former or sticking agent may be selected from polyvinyl acetates, polyvinyl acetate copolymers, hydrolyzed polyvinyl acetates, polyvinylpyrrolidone-vinyl acetate copolymer, polyvinyl alcohols, polyvinyl alcohol copolymers, polyvinyl methyl ether, polyvinyl methyl ether-maleic anhydride copolymer, waxes, latex polymers, celluloses including ethylcelluloses and methylcelluloses, hydroxymethylcelluloses, hydroxy-propylcellulose, hydroxymethylpropylcelluloses, polyvinylpyrrolidones, alginates, dextrins, malto-dextrins, polysaccharides, fats, oils, proteins, karaya gum, jaguar gum, tragacanth gum, polysaccharide gums, mucilage, gum arabics, shellacs, vinylidene chloride polymers and copolymers, soybean-based protein polymers and copolymers, lignosulfonates, acrylic copolymers, starches, polyvinylacrylates, zeins, gelatin, carboxymethylcellulose, chitosan, polyethylene oxide, acrylimide polymers and copolymers, polyhydroxyethyl acrylate, methylacrylimide monomers, alginate, ethylcellulose, polychloroprene and syrups or mixtures thereof. Preferred film formers and adhesive agents include polymers and copolymers of vinyl acetate, poly-vinylpyrrolidone-vinyl acetate copolymer and water-soluble waxes. Particularly preferred are polyvinylpyrrolidone-vinyl acetate copolymers and water-soluble waxes. The above-identified polymers include those known in the art and for example some are identified as Agrimer® VA 6 and Licowax® KST. The amount of film former or sticking agent in the formulation is generally in the range of about 0.001 to 100% of the weight of the propagating material. For large seeds the amount of film former or sticking agent is typically in the range of about 0.05 to 5% of the seed weight; for small seeds the amount is typically in the range of about 1 to 100%, but can be greater than 100% of seed weight in pelleting. For other propagating materials the amount of film former or sticking agent is typically in the range of 0.001 to 2% of the propagating material weight.

Materials known as formulation aids may also be used in propagating material treatment coatings of the invention and are well known to those skilled in the art. Formulation aids assist in the production or process of propagating material treatment and include, but are not limited, to dispersants, surfactants, carriers, antifoams and dyes. Useful dispersants can include highly water-soluble anionic surfactants like Borresperse™ CA, Morwet® D425 and the like. Useful surfactants can include highly water-soluble nonionic surfactants like Pluronic® F108, Brij® 78 and the like. Useful carriers can include liquids like water and oils which are water-soluble such as alcohols. Useful carriers can also include fillers like woodflours, clays, activated carbon, diatomaceous earth, fine-grain inorganic solids, calcium carbonate and the like. Clays and inorganic solids which may be used include calcium bentonite, kaolin, china clay, talc, perlite, mica, vermiculite, silicas, quartz powder, montmorillonite and mixtures thereof. Antifoams can include water dispersible liquids comprising polyorganic siloxanes like Rhodorsil® 416. Dyes can include water dispersible liquid colorant compositions like Pro-Ized® Colorant Red. One skilled in the art will appreciate that this is a non-exhaustive list of formulation aids and that other recognized materials may be used depending on the propagating material to be coated and the compound of Formula I used in the coating. Suitable examples of formulation aids include those listed herein and those listed in McCutcheon's 2001, Volume 2: Functional Materials, published by MC Publishing Company. The amount of formulation aids used may vary, but generally the weight of the components will be in the range of about 0.001 to 10000% of the propagating material weight, with the percentages above 100% being mainly used for pelleting small seed. For nonpelleted seed generally the amount of formulating aids is about 0.01 to 45% of the seed weight and typically about 0.1 to 15% of the seed weight. For propagating materials other than seeds, the amount of formulation aids generally is about 0.001 to 10% of the propagating material weight.

Conventional means of applying seed coatings may be used to carry out the coating of the invention. Dusts or powders may be applied by tumbling the propagating material with a formulation comprising a Formula I compound and a sticking agent to cause the dust or powder to adhere to the propagating material and not fall off during packaging or transportation. Dusts or powders can also be applied by adding the dust or powder directly to the tumbling bed of propagating materials, followed by spraying a carrier liquid onto the seed and drying. Dusts and powders comprising a Formula I compound can also be applied by treating (e.g., dipping) at least a portion of the propagating material with a solvent such as water, optionally comprising a sticking agent, and dipping the treated portion into a supply of the dry dust or powder. This method can be particularly useful for coating stem cuttings. Propagating materials can also be dipped into compositions comprising Formula I formulations of wetted powders, solutions, suspoemulsions, emulfiable concentrates and emulsions in water, and then dried or directly planted in the growing medium. Propagating materials such as bulbs, tubers, corms and rhizomes typically need only a single coating layer to provide a biologically effective amount of a Formula I compound.

Propagating materials may also be coated by spraying a suspension concentrate directly into a tumbling bed of propagating materials and then drying the propagating materials. Alternatively, other formulation types like wetted powders, solutions, suspoemulsions, emulsifiable concentrates and emulsions in water may be sprayed on the propagating materials. This process is particularly useful for applying film coatings to seeds. Various coating machines and processes are available to one skilled in the art. Suitable processes include those listed in P. Kosters et al., Seed Treatment: Progress and Prospects, 1994 BCPC Monograph No. 57 and the references listed therein. Three well-known techniques include the use of drum coaters, fluidized bed techniques and spouted beds. Propagating materials such as seeds may be presized prior to coating. After coating the propagating materials are dried and then optionally sized by transfer to a sizing machine. These machines are known in the art for example, as a typical machine used when sizing corn (maize) seed in the industry.

For coating seed, the seed and coating material are mixed in any variety of conventional seed coating apparatus. The rate of rolling and coating application depends upon the seed. For large oblong seeds such as those of cotton, a satisfactory seed coating apparatus comprises a rotating type pan with lifting vanes turned at sufficient rpm to maintain a rolling action of the seed, facilitating uniform coverage. For seed coating formulations applied as liquids, the seed coating must be applied over sufficient time to allow drying to minimize clumping of the seed. Using forced air or heated forced air can facilitate an increased rate of application. One skilled in the art will also recognize that this process may be a batch or continuous process. As the name implies, a continuous process allows the seeds to flow continuously throughout the product run. New seeds enter the pan in a steady stream to replace coated seeds exiting the pan.

The seed coating process of the present invention is not limited to thin film coating and may also include seed pelleting. The pelleting process typically increases the seed weight from 2 to 100 times and can be used to also improve the shape of the seed for use in mechanical seeders. Pelleting compositions generally contain a solid diluent, which is typically an insoluble particulate material, such as clay, ground limestone, powdered silica, etc., to provide bulk in addition to a binder such as an artificial polymer (e.g., polyvinyl alcohol, hydrolyzed polyvinyl acetates, polyvinyl methyl ether, polyvinyl methyl ether-maleic anhydride copolymer, and polyvinylpyrrolidinone) or natural polymer (e.g., alginates, karaya gum, jaguar gum, tragacanth gum, polysaccharide gum, mucilage). After sufficient layers have been built up, the coat is dried and the pellets graded. A method for producing pellets is described in Agrow, The Seed Treatment Market, Chapter 3, PJB Publications Ltd., 1994.

Seed varieties and seeds with specific transgenic traits may be tested to determine which seed treatment options and application rates may complement such varieties and transgenic traits in order to enhance yield. Further, the good root establishment and early emergence that results from the proper use of the compound of formula I seed treatment may result in more efficient nitrogen use, a better ability to withstand drought and an overall increase in yield potential of a variety or varieties containing a certain trait when combined with a seed treatment.

In another embodiment of the invention, the composition is applied as a foliar formulation. Such formulations will generally include at least one additional component selected from the group consisting of surfactants, solid diluents and liquid diluents, which serve as a carrier. The formulation or composition ingredients are selected to be consistent with the physical properties of the active ingredient, mode of application and environmental factors such as soil type, moisture and temperature.

Useful formulations include both liquid and solid compositions. Liquid compositions include solutions (including emulsifiable concentrates), suspensions, emulsions (including microemulsions and/or suspoemulsions) and the like, which optionally can be thickened into gels. The general types of aqueous liquid compositions are soluble concentrate, suspension concentrate, capsule suspension, concentrated emulsion, microemulsion and suspoemulsion. The general types of nonaqueous liquid compositions are emulsifiable concentrate, microemulsifiable concentrate, dispersible concentrate and oil dispersion.

The general types of solid compositions are dusts, powders, granules, pellets, prills, pastilles, tablets, filled films (including seed coatings) and the like, which can be water-dispersible (“wettable”) or water-soluble. Films and coatings formed from film-forming solutions or flowable suspensions are particularly useful for seed treatment. Active ingredient can be (micro)encapsulated and further formed into a suspension or solid formulation; alternatively the entire formulation of active ingredient can be encapsulated (or “overcoated”). Encapsulation can control or delay release of the active ingredient. An emulsifiable granule combines the advantages of both an emulsifiable concentrate formulation and a dry granular formulation. High-strength compositions are primarily used as intermediates for further formulation.

Sprayable formulations are typically extended in a suitable medium before spraying. Such liquid and solid formulations are formulated to be readily diluted in the spray medium, usually water. Spray volumes can range from about one to several thousand liters per hectare, but more typically are in the range from about ten to several hundred liters per hectare. Sprayable formulations can be tank mixed with water or another suitable medium for foliar treatment by aerial or ground application, or for application to the growing medium of the plant. Liquid and dry formulations can be metered directly into drip irrigation systems or metered into the furrow during planting. Liquid and solid formulations can be applied onto seeds of crops and other desirable vegetation as seed treatments before planting to protect developing roots and other subterranean plant parts and/or foliage through systemic uptake. Effective foliar formulations will typically contain from about 10⁻⁵ M to 10⁻¹² M of the composition. In a preferred embodiment, formulations contain from about 10⁻⁶ M to 10⁻¹⁰ M of the compound of formula I.

In another embodiment of the invention, the composition is applied to soil either prior to or following planting of plant propagating materials. Compositions can be applied as a soil drench of a liquid formulation, a granular formulation to the soil, a nursery box treatment or a dip of transplants. Of note is a composition of the present invention in the form of a soil drench liquid formulation. Of further note is this method wherein the environment is soil and the composition is applied to the soil as a soil drench formulation. Other methods of contact include application of a compound or a composition of the invention by direct and residual sprays, aerial sprays, gels, seed coatings, microencapsulations, systemic uptake, baits, ear tags, boluses, foggers, fumigants, aerosols, dusts and many others. One embodiment of a method of contact is a dimensionally stable fertilizer granule, stick or tablet comprising a compound or composition of the invention. Effective soil formulations will typically contain from about 10⁻⁵ M to 10⁻¹² M of the composition. In a preferred embodiment, formulations contain from about 10⁻⁶ M to 10⁻¹⁰ M of the compound of formula I.

The method of this invention is applicable to virtually all plant species. Seeds that can be treated include, for example, wheat (Triticum aestivum L.), durum wheat (Triticum durum Desf.), barley (Hordeum vulgare L.), oat (Avena sativa L.), rye (Secale cereale L.), maize (Zea mays L.), sorghum (Sorghum vulgare Pers.), rice (Oryza sativa L.), wild rice (Zizania aquatica L.), millet (Eleusine coracana, Panicum miliaceum), cotton (Gossypium barbadense L. and G. hirsutum L.), flax (Linum usitatissimum L.), sunflower (Helianthus annuus L.), soybean (Glycine max Merr.), garden bean (Phaseolus vulgaris L.), lima bean (Phaseolus limensis Macf.), broad bean (Vicia faba L.), garden pea (Pisum sativum L.), peanut (Arachis hypogaea L.), alfalfa (Medicago sativa L.), beet (Beta vulgaris L.), garden lettuce (Lactuca sativa L.), rapeseed (Brassica rapa L. and B. napus L.), cole crops such as cabbage, cauliflower and broccoli (Brassica oleracea L.), turnip (Brassica rapa L.), leaf (oriental) mustard (Brassica juncea Coss.), black mustard (Brassica nigra Koch), tomato (Lycopersicon esculentum Mill.), potato (Solanum tuberosum L.), pepper (Capsicum frutescens L.), eggplant (Solanum melongena L.), tobacco (Nicotiana tabacum), cucumber (Cucumis sativus L.), muskmelon (Cucumis melo L.), watermelon (Citrullus vulgaris Schrad.), squash (Curcurbita pepo L., C. moschata Duchesne. and C. maxima Duchesne.), carrot (Daucus carota L.), zinnia (Zinnia elegans Jacq.), cosmos (e.g., Cosmos bipinnatus Cay.), chrysanthemum (Chrysanthemum spp.), sweet scabious (Scabiosa atropurpurea L.), snapdragon (Antirrhinum majus L.), gerbera (Gerbera jamesonii Bolus), babys-breath (Gypsophila paniculata L., G. repens L. and G. elegans Bieb.), statice (e.g., Limonium sinuatum Mill., L. sinense Kuntze.), blazing star (e.g., Liatris spicata Willd., L. pycnostachya Michx., L. scariosa Willd.), lisianthus (e.g., Eustoma grandiflorum (Raf.) Shinn), yarrow (e.g., Achillea filipendulina Lam., A. millefolium L.), marigold (e.g., Tagetes patula L., T. erecta L.), pansy (e.g., Viola cornuta L., V. tricolor L.), impatiens (e.g., Impatiens balsamina L.) petunia (Petunia spp.), geranium (Geranium spp.) and coleus (e.g., Solenostemon scutellarioides (L.) Codd). Not only seeds, but also rhizomes, tubers, bulbs or corms, including viable cuttings thereof, can be treated according to the invention from, for example, potato (Solanum tuberosum L.), sweet potato (Ipomoea batatas L.), yam (Dioscorea cayenensis Lam. and D. rotundata Poir.), garden onion (e.g., Allium cepa L.), tulip (Tulipa spp.), gladiolus (Gladiolus spp.), lily (Lilium spp.), narcissus (Narcissus spp.), dahlia (e.g., Dahlia pinnata Cay.), iris (Iris germanica L. and other species), crocus (Crocus spp.), anemone (Anemone spp.), hyacinth (Hyacinth spp.), grape-hyacinth (Muscari spp.), freesia (e.g., Freesia refracta Klatt., F. armstrongii W. Wats), ornamental onion (Allium spp.), wood-sorrel (Oxalis spp.), squill (Scilla peruviana L. and other species), cyclamen (Cyclamen persicum Mill. and other species), glory-of-the-snow (Chionodoxa luciliae Boiss. and other species), striped squill (Puschkinia scilloides Adams), calla lily (Zantedeschia aethiopica Spreng., Z. elliottiana Engler and other species), gloxinia (Sinnigia speciosa Benth. & Hook.) and tuberous begonia (Begonia tuberhybrida Voss.). Stem cuttings can be treated according to this invention include those from such plants as sugarcane (Saccharum officinarum L.), carnation (Dianthus caryophyllus L.), florists chrysanthemum (Chrysanthemum mortifolium Ramat.), begonia (Begonia spp.), geranium (Geranium spp.), coleus (e.g., Solenostemon scutellarioides (L.) Codd) and poinsettia (Euphorbia pulcherrima Willd.). Leaf cuttings which can be treated according to this invention include those from begonia (Begonia spp.), african-violet (e.g., Saintpaulia ionantha Wendl.) and sedum (Sedum spp.). The above recited cereal, vegetable, ornamental (including flower) and fruit crops are illustrative, and should not be considered limiting in any way. For reasons of economic importance, preferred embodiments of this invention include wheat, rice, maize, barley, sorghum, oats, rye, millet, soybeans, peanuts, beans, rapeseed, canola, sunflower, sugar cane, potatoes, sweet potatoes, cassava, sugar beets, tomatoes, plantains and bananas, and alfalfa.

All publications and patent applications mentioned in the specification are indicative of the level of those skilled in the art to which this invention pertains. All publications and patent applications are herein incorporated by reference to the same extent as if each individual publication or patent application was specifically and individually indicated to be incorporated by reference.

Although the foregoing invention has been described in some detail by way of illustration and example for purposes of clarity of understanding, it will be obvious that certain changes and modifications may be practiced within the scope of the appended claims.

### Example 1

### Effect of TAGM on Plant Emergence, Flowering, Vigor and Biomass of Potatoes Grown Under Field Conditions in 2011

### Materials and Methods

A potato field trial was conducted to evaluate the effects of TAGM on plant emergence, flowering, vigor and biomass in Superior potatoes (Solanum tuberosum) planted near Breslau, Ontario, Canada, in 2011. Seed treatments included an Untreated Control, TAGM applied as a seed treatment, and TAGM applied as a seed treatment followed by two foliar TAGM applications. Aqueous solutions of TAGM were applied at a 10⁻⁷ M concentration to seed pieces using a spray nozzle and left to soak on a plastic sheet for 20 minutes. Foliar TAGM applications were performed 36 and 45 days after planting. Plants were sprayed using a four-nozzle hollow-cone boom containing ceramic disks and CO₂ propellant at a speed of 4.5 km/h and 40 psi. The 36 day application utilized a 2.0 L mix size and spray rate of 200 L/ha water volume. The 45 day application utilized a 3.0 L mix size and spray rate of 300 L/ha water volume. Seeds designated for use as the Untreated Control also received the fungicide maintenance treatment.

The seed pieces were beginning to sprout when planted on June 8^{th} in a loam composed of 34% sand, 48% silt, 18% clay and 2.9% organic matter. The soil had a pH of 7.4 and cationic exchange capacity of 19.3.

Potatoes were planted at a rate of 25,000 seed pieces/ha to a depth of 20 cm and hilled using a tractor mounted potato hiller. Weeds were controlled using 3 L/ha of 40.6 wt % linuron. Insects were controlled using 250 ml/ha 18.4 wt % chlorantraniliprole and 80 grams g/ha 70 wt % acetamiprid insecticides. Disease was controlled using tank mix of 1.6 kg/ha 75 wt % mancozeb M and 225 g/ha 60 wt % cymoxanil fungicides. Before harvest, plants were sprayed twice (seven days apart) with 39.5 wt % diquat dibromide herbicide at a rate of two L/ha. All of the products are industry standards and representative of what is used in commercial production.

The trial was conducted using a randomized complete block design with a plot size of 2 m by 8 m with a 100 cm row spacing, 30 cm plant spacing and four replications. Due to wet weather, the soil was damp and cloddy during the planting and hilling process.

### Results

Percent emergence was observed at 20 and 28 DAP (Table 1). No significant differences were observed with either TAMG treatment compared to the Untreated Control.

TABLE 1
Effect of TAGM on Time to Potato Emergence (%)

| Treatment | 20 DAP | 28 DAP |
|---|---|---|
| Untreated | 37a | 40a |
| 10⁻⁷M TAMG | 39a | 40a |
| 10⁻⁷M TAMG + Foliar | 38a | 39a |

Treatments followed by the same letter in a column are not significantly different when compared using Tukey's LSD test.

Flowering was observed 40 days after TAGM application (Table 2). A significant increase in flowering numbers was observed with the TAGM+Foliar treatment compared to the Untreated Control.

TABLE 2
Effect of TAGM on Time to Potato Flowering (%)

| Treatment | 40 DAP |
|---|---|
| Untreated | 0.5a |
| 10⁻⁷M TAMG | 34b |
| 10⁻⁷M TAMG + Foliar | 31b |

Treatments followed by the same letter in a column are not significantly different when compared using Tukey's LSD test.

Crop vigor was observed at 20, 28, 40, and 48 DAP (Table 3). Vigor was determined by visual assessment and comparative scoring of plant growth parameters including height, width, and ground cover compared to control treatments. Treatments were compared on a “Vigor Scale” of 1 to 5 as follows:

1=Visually inferior to untreated check
2=Slightly worse than untreated check
3=Same as untreated check
4=Slightly better than untreated check
5=Visually superior to untreated check

Both TAGM treatments exhibited significantly increased crop vigor versus the Untreated Control at all time points.

TABLE 3
Effect of TAGM on Crop Vigor (1-5 Scale)

| | | | | |
|---|---|---|---|---|
| Treatment | 20 DAP | 28 DAP | 40 DAP | 49 DAP |

| | | | | |
|---|---|---|---|---|
| Untreated | 3.0a | 3.0a | 3.0a | 3.0a |
| 10⁻⁷M TAMG | 5.0b | 4.4b | 4.1b | 4.4b |
| 10⁻⁷M TAMG + Foliar | 5.0b | 4.5b | 4.0b | 4.5b |

Treatments followed by the same letter in a column are not significantly different when compared using Tukey's LSD test.

Potato plant biomass was determined at 117 DAP by harvesting five plants above ground level from each plot (Table 4). A non-statistically significant biomass increase was observed for the 10⁻⁷ M TAGM treatment versus the Untreated Control.

TABLE 4
Effect of TAGM on Plant Biomass

| Treatment | kg/5 Plants |
|---|---|
| Untreated | 2.10a |
| 10⁻⁷M TAMG | 2.40a |
| 10⁻⁷M TAMG + Foliar | 2.11a |

Treatments followed by the same letter in a column are not significantly different when compared using Tukey's LSD test.

### Example 2

### Effect of TAGM on Plant Emergence, Vigor and Tillering on Spring Barley Grown Under Field Conditions in 2011

### Materials and Methods

A spring barley field trial was conducted to evaluate the effects of TAGM on plant emergence, vigor and tillering in AC Metcalf spring barley (Hordeum vulgare) planted near Wetaskiwin, Alberta, Canada, in 2011. Seed treatments included an Untreated Control, 10⁻⁷ M TAGM seed coating, 10⁻⁷ M TAGM seed coating followed by a TAGM foliar treatment (10⁻⁷ M NPG+Foliar), 10⁻⁶ M natural LCO, and 10⁻⁶ M commercial LCO plus a commercial rhizobia inoculant (LCO+RI). The natural LCO was provided by Dr. Don Smith (McGill University, Montreal, Canada) using the basic method described in Soulemanov, A., et al., in Microbiol. Res., 157: 25-28 (2005).

Seed coating was performed by injecting 7 mL of aqueous TAGM solution per 100 g barley seed into the coating machine followed by treatment and drying. Upon completion of drying, TAGM-coated seeds were placed in the coating machine a second time and injected with a maintenance fungicide treatment of tebuconazole 6.7 g/L+thiram 222 g/L at a rate of 225 mL/100 kg seed for protection against seed borne diseases. The LCO and LCO+RI treatments were performed using a similar two-step process. Seeds designated for use as the Untreated Control received the fungicide maintenance treatment alone.

Foliar TAGM was applied 47 days after planting. Plants were sprayed using a four-nozzle hollow-cone boom and CO₂ propellant at a speed of 10.8 km/h and 40 psi, with a mix size of 1.0 L and spray rate of 110 L/ha water volume. Seeds designated for use as the Untreated Control also received the fungicide maintenance treatment.

Treated seeds were sent to the DuPont Wetaskiwin, Alberta, Canada, Research Station and planted on May 19^{th} in a loam soil with 29% sand, 46% silt, 25% clay and 4.8% organic matter. The soil had a pH of 6.2 and cationic exchange capacity of 33. Barley was planted at a rate of 100 kg seeds/ha to a depth of 2.5 cm. Weeds were controlled using 60 grams ai/ha pinoxaden, 30 grams/ha thifensulfuron methyl, and 280 grams ai/ha 4-chloro-2-methylphenox acetic acid, 2-ethylhexyl ester. Adigor surfactant was used at a rate of 700 ml/ha. All of the products used are considered industry standards and representative of what is used in commercial production.

The trial was conducted using a randomized complete block design with a plot size of 2 m by 6 m with 22.9 cm row spacing, 3.3 cm plant spacing and four replications. Height and yield data was not collected in this trial due to a large hailstorm on Jul. 18, 2011.

### Results

Plant emergence was observed at 11 and 14 DAP. No statistically significant difference in emergence was observed among treatments. Crop vigor was observed 11 and 14 days DAP using the vigor scale described in Example 1. No statistically significant difference in crop vigor was observed between treatments. Percent Tillering (numbers of tillers per plant) was observed at 24 DAP. No statistically significant difference was observed between treatments.

### Example 3

### Effect of TAGM on Plant Emergence, Vigor, Tillering, Biomass and Yield of Spring Wheat Under Field Conditions in 2011

### Materials and Methods

A field trial was conducted to evaluate the effects of TAGM on plant emergence, crop vigor, tillering, biomass and yield in spring wheat (Triticum aestivum) planted near Breslau, Ontario, Canada, in 2011. Seed treatments included an Untreated Control, 10⁻⁷ M TAGM, 10⁻⁷ M TAGM followed by two foliar TAGM applications, 10⁻⁶ M natural LCO, and 10⁻⁶ M commercial LCO plus a commercial rhizobia inoculant (LCO+RI). The natural LCO was provided by Dr. Don Smith (McGill University, Montreal, Canada) and prepared as described in Example 2. Seed coating was performed by injecting 7 mL of aqueous TAGM solution per 100 g wheat seed into a coating machine followed by treatment and drying. Upon completion of drying, the TAGM coated seeds were placed in the coating machine a second time and injected with a maintenance fungicide treatment of tebuconazole 6.7 g/L+thiram 222 g/L at a rate of 225 mL/100 kg seed for protection against seed borne diseases. The LCO and LCO+RI treatments were performed using a similar two-step process. Seeds designated for use as the Untreated Control received the fungicide maintenance treatment alone.

Treated seeds were sent to the DuPont Breslau, Ontario Research Station and planted on June 8^{th} in a loam composed of 34% sand, 48% silt, 18% clay and 2.9% organic matter. The soil had a pH of 7.4 and cationic exchange capacity of 19.3. Spring wheat was planted at a rate of 100 kg seeds/ha to a depth of 3 cm. Weeds were controlled using 8.79 wt % fenoxyprop-P-ethyl at a rate of 770 mL/ha and the combination of 33.33 wt % thifensulfuron methyl and 16.67 wt % tribenuron methyl at a rate of 30 g/ha. Disease was controlled using 23.6 wt % pyraclostrobin fungicide at a rate of 0.4 L/ha. All of the products used are considered industry standards and representative of what is used in commercial production.

The trial was conducted using a randomized complete block design with a plot size of 2.5 m by 8 m with 17.8 cm row spacing, 3.3 cm plant spacing and four replications.

Foliar TAMG applications were performed 36 and 49 days after planting. The treatments were sprayed using a four nozzle hollow-cone boom and CO₂ propellant at a speed of 4.5 km/h and 40 psi. The 36 day application utilized a mix size of 2.0 L and spray rate of 200 L/ha water volume. The 49 day application utilized a mix size of 3.0 L and spray rate of 300 L/ha water volume.

### Results

Percent emergence was observed at 13 and 35 DAP (Table 5). No statistically significant difference in crop emergence was observed between treatments.

TABLE 5
Effect of TAGM on Spring Wheat Crop Emergence (%)

| Treatment | 13 DAP | 35 DAP |
|---|---|---|
| Untreated | 49a | 100a |
| 10⁻⁷M TAMG | 50a | 100a |
| 10⁻⁷M TAMG + Foliar | 50a | 100a |
| 10⁻⁶M LCO | 55a | 100a |
| 10⁻⁶M LCO + RI | 50a | 100a |

Treatments followed by the same letter in a column are not significantly different when compared using Tukey's LSD test.

Crop vigor was observed 35, 40, and 52 DAP using the vigor scale described for Table 3 in Example 1 (Table 6). A significant increase in crop vigor was observed for the TAGM treatments versus the Untreated Control at 40 DAP. TAGM treatments also exhibited a directional improvement in crop vigor at 35 DAP and 52 DAP. No statistically significant differences were observed between the LCO treatments and the Untreated Control.

TABLE 6
Effect of TAGM on Spring Wheat Crop Vigor
Crop Vigor (1-5 scale)

| Treatment | 35 DAP | 40 DAP | 52 DAP |
|---|---|---|---|
| Untreated | 3.0a | 3.0a | 3.0a |
| 10⁻⁷M TAMG | 3.5a | 3.6b | 3.5a |
| 10⁻⁷M TAMG + | 3.6a | 3.6b | 3.5a |
| Foliar | | | |
| 10⁻⁶M LCO | 3.4a | 3.3a | 3.3a |
| 10⁻⁶M LCO + RI | 3.3a | 3.0a | 3.3a |

Treatments followed by the same letter in a column are not significantly different when compared using Tukey's LSD test.

Tillering (number of tillers per plant) was observed at 35 days DAP (Table 7). A non-statistically significant increase in tillering was observed for the TAGM and LCO treatments versus the Untreated Control.

TABLE 7
Effect of TAGM on Spring Wheat Tillering (tillers/plant)

| Treatment | 35 DAP |
|---|---|
| Untreated | 6a |
| 10⁻⁷M TAMG | 9a |
| 10⁻⁷M TAMG + | 8a |
| Foliar | |
| 10⁻⁶M LCO | 8a |
| 10⁻⁶M LCO + RI | 7a |

Treatments followed by the same letter in a column are not significantly different when compared using Tukey's LSD test.

Plant Biomass was determined at 82 DAP by harvesting the entire aerial portion of the plants from each plot (Table 8). A non-statistically significant increase in biomass was determined for the TAGM and LCO treatments versus the Untreated Control.

TABLE 8
Effect of TAGM on Spring Wheat Biomass (kg/plant)

| Treatment | 82 DAP |
|---|---|
| Untreated | 0.176a |
| 10⁻⁷M TAMG | 0.224a |
| 10⁻⁷M TAMG + | 0.200a |
| Foliar | |
| 10⁻⁶M LCO | 0.215a |
| 10⁻⁶M LCO + RI | 0.204a |

Treatments followed by the same letter in a column are not significantly different when compared using Tukey's LSD test.

Grain yield was determined by harvesting the entire eight meters of the plot and transforming the data to kg/ha (Table 9). Yields are not corrected for differences in emergence rates. A non-statistically significant yield increase was observed for the TAGM and LCO treatments versus the Untreated Control.

TABLE 9
Effect of TAGM on Spring Wheat Yield (kg/ha)

| Treatment | kg/ha |
|---|---|
| Untreated | 1113a |
| 10⁻⁷M TAMG | 1350a |
| 10⁻⁷M TAMG + Foliar | 1225a |
| 10⁻⁶M LCO | 1288a |
| 10⁻⁶M LCO + RI | 1163a |

Treatments followed by the same letter in a column are not significantly different when compared using Tukey's LSD test.

### Example 4

### Effect of TAGM on Early Growth, Height, Days to Maturity and Yield of Canola Grown Under Field Conditions in 2011

### Materials and Methods

Three canola (Brassica napus) field trials were conducted in the spring of 2011 to evaluate the effects of TAGM on early growth, plant height, days to maturity and yield for Pioneer hybrid 45H29 planted at research sites near Carman, Neepawa, and Treherne (Manitoba, Canada). Seed treatments included an Untreated Control, 10⁻⁷ M NPG, and a mixture of a commercial LCO and commercial rhizobia. An aqueous solution of TAGM was applied at 0.25 L/100 kg seed by soaking the seeds in aqueous solutions of the respective treatments for 15 minutes followed by air drying on a tray. Untreated Control seeds were treated identically with the exception of being soaked in water without added TAGM. The LCO/rhizobia mixture was applied to seeds at the manufacturers' recommended rates. Prior to TAGM or LCO application, all seeds were treated with a liquid mixture of pesticides consisting of 20.7% thiamethoxam, 1.25% difenoconazole, 0.39% metalaxyl-M, and 0.13% fludioxonil applied at a rate of 15 mL/kg of seed to minimize the effect of disease and insect damage.

The trial was conducted using a randomized complete block design with a plot size of 1.5 m by 6 m with a 19 cm row spacing and four replications. Canola was planted at a rate of 180 seeds/m⁻² to a depth 1.25 cm. Border plots were utilized to minimize any border effect on seed yield. An herbicide mixture of sethoxidim (445 g ai/ha), ethametsulfuron-methyl (22 g ai/ha) and clopyralid (83 g ai/ha) was applied at the 2-3 leaf stage to control grassy and broadleaf weeds. Plants were also sprayed with boscalid (99 g ai/ha) at the 30% bloom stage to minimize the impact of sclerotinia stem rot on seed yield. Plants were harvested by straight cutting at physical maturity (87-88 days). All results were averaged across locations for individual treatments.

### Results

Early growth was scored on a 1-9 scale using a subjective evaluation of the ‘healthiness’ of plants and the soil surface area covered by their leaves when the plants are in the 4-6 leaf stage. This was done by observing a sufficient number of row/plots, including checks if possible, to establish a range from 1 (unhealthy/weak looking plants with small leaf coverage) to 9 (healthy/strong looking plants with large leaf coverage). No significant difference on early growth was observed between treatments.

Plant height was measured at plant maturity. No significant difference on plant height was observed between treatments.

Days to maturity was measured from time of planting to physiological maturity, which was recorded in days from planting until the seeds in the pod, one third of the way up the main raceme, have changed color to black in 50% of the plants in a given row or plot. No significant difference in time to physiological maturity was observed between treatments.

Yield was measured in bushels per acre of mature seed. Final harvest yield was corrected to 10% moisture. No significant difference in yield was observed between treatments.

### Example 5

### Effect of TAGM on Stand and Yield of Corn Grown Under Field Conditions in 2011

### Materials and Methods

The effect of TAGM on corn (Zea mays) stand and yield was evaluated in Pioneer seed treatment field trials during the 2011 growing season at research sites near Ames, Iowa, Bloomington, Ill., Champaign, Ill., and Ridgeway, Ill. Pioneer Hi-Bred hybrid P0902XR corn was planted in four row corn plots with 30 in row spacing and a plot length of 20 feet. At all research sites, each treatment was replicated four times with plant population data (number of plants per two middle plot rows) collected at the V4 corn growth stage. Corn grain yield data (bu/a) was collected at harvest. Plots were managed by utilizing crop management practices common to each of the research site locations.

All seed treatments were composed of a standard fungicide seed treatment (FST) and insecticide seed treatment (1ST) applied with and without TAGM (Table 10). TAGM was either applied in a slurry mixture (TAGM-SL) with all other treatment components or as a pretreatment (TAGM-PT) prior to the addition of the other seed treatment components. For both experimental treatments TAGM was applied to corn seed using a 10⁻⁷ M solution.

TABLE 10
Seed Treatment, Application Rates and Application Methods in Corn.

| Treatment | | |
|---|---|---|
| Number | Treatment Description | Application Method |
| 1 | FST/IST | Premixed components applied as |
| | | slurry |
| 2 | TAMG-SL/FST/IST | Premixed components applied as |
| | | slurry |
| 3 | TAMG-PT/FST/IST | TAGM applied as seed |
| | | pretreatment. After seed drying |
| | | the remaining premixed |
| | | components were applied as a |
| | | slurry |

FST—fungicidal seed treatment (azoxystrobin, fludioxonil, mefenoxam, tebuconazole);
IST—insecticidal seed treatment (thiamethoxam)

### Results

Treatments were evaluated using plant population data collected from the V4 corn growth stage and corn grain yield at harvest. Experimental Treatments 2 and 3 did not provide a statistically significant yield improvement versus Treatment 1 (standard treatment) with respect to either absolute or corrected yield (bu/a) (Table 11).

TABLE 11
Corn plant population and yield response to seed treatments.

| | | Plant | | Corrected |
|---|---|---|---|---|
| | | Population | | Yield* |
| Number | Treatment Code | (plants/acre) | Yield (bu/a) | (bu/a) |
| 1 | FST/IST | 30,243 | 194.06a | 194.06a |
| 2 | TAMG-SL/FST/IST | 30,434 | 188.23ab | 188.16a |
| 3 | TAMG-PT/FST/IST | 28,999 | 179.46b | 180.63b |

Data were analyzed using an analysis of variance for a randomized complete block design. Estimates were generated and significance declared at P ≦ 0.20.
*Yield for Treatments 2 and 3 corrected to plant population of Treatment 1.

TAGM treatments 2 and 3 did not provide a statistically significant yield improvement at any of the four locations (Table 12). TAGM treatments did, however, exhibit a numerical yield advantage over Treatment 1 at the Ridgeway location, which was under the greatest environmental stress among the four locations during the 2011 growing season.

TABLE 12
Corn grain yield response to TAGM seed treatments across locations.

| Treatment | | Treatment | Estimated Yield |
|---|---|---|---|
| Number | Location | Description | (bu/a) |
| 1 | Ames, IA | FST/IST | 199.53a |
| 2 | | TAMG-SL/FST/IST | 181.66b |
| 3 | | TAMG-PT/FST/IST | 175.86b |
| 1 | Bloomington, IL | FST/IST | 194.79a |
| 2 | | TAMG-SL/FST/IST | 181.50ab |
| 3 | | TAMG-PT/FST/IST | 174.86b |
| 1 | Champaign, IL | FST/IST | 207.13a |
| 2 | | TAMG-SL/FST/IST | 205.70a |
| 3 | | TAMG-PT/FST/IST | 182.24a |
| 1 | Ridgeway, IL | FST/IST | 174.80a |
| 2 | | TAMG-SL/FST/IST | 183.45a |
| 3 | | TAMG-PT/FST/IST | 179.87a |

Data were analyzed using an analysis of variance for a randomized complete block design. Estimates were generated and significance declared at P ≦ 0.20.

Data were analyzed using an analysis of variance for a randomized complete block design. Estimates were generated and significance declared at P≦0.20.

### Example 6

### Effect of TAGM on the Yield of Soybeans Grown Under Field Conditions in 2011

### Materials and Methods

The effect of TAGM on soybean (Glycine max) yield was evaluated in Pioneer seed treatment field trials during the 2011 growing season at research sites near Ames, Iowa, Bloomington, Ill., Champaign, Ill., Eldora, Iowa, and Ridgeway, Ill. The field trials consisted of Pioneer 93Y70 brand soybeans planted at the Illinois research sites and Pioneer 92Y80 brand soybeans planted at the Iowa research sites. Soybeans were planted in four row plots with 30 inch row spacing and a plot length of 20 feet. At all research sites, each treatment was replicated four times with soybean grain yield data (bushels/acre) collected at harvest. Plots were managed by utilizing crop management practices common to each of the research site locations. The trial included six treatments, which are summarized in Table 13. The pesticides, rhizobia inoculant and LCO were formulated into seed coatings at standard commercial application rates. TAGM was either applied in a slurry mixture with all other treatment components (Treatment 5) or as a pretreatment to all other seed treatment components (Treatment 6). Both TAGM treatments were applied to soybean seed using a 10⁻⁷ M concentration solution.

TABLE 13
Seed treatment, application rates and application methods in soybeans.

| Treatment | Treatment | |
|---|---|---|
| Number | Description | Application Method |
| 1 | Untreated | None |
| 2 | RI | Premixed components applied as slurry |
| 3 | FST/IST | Premixed components applied as slurry |
| 4 | FST/IST/RI/LCO | Premixed components applied as slurry |
| 5 | TAMG-SL/FST/IST | Premixed components applied as slurry |
| 6 | TAMG-PT/FST/IST | TAGM was applied as seed |
| | | pretreatment. After seed drying the |
| | | remaining premixed components were |
| | | applied as a slurry |

FST—fungicidal seed treatment (metalaxyl + trifloxystrobin);
IST—insecticidal seed treatment (imidocloprid);
RI—rhizobia inoculant;
LCO—lipochitooligosaccharide

### Results

There was no significant treatment difference between in soybean grain yield among the four experimental treatments (Table 14). However, the grain yield of Treatment 5 was statistically greater than the Untreated Control and comparable to Treatment 4, which was formulated with an industry standard LCO.

TABLE 14
Soybean grain yield response to TAGM seed treatments
across locations.

| Treatment # | Treatment Description | Yield (BPA) |
|---|---|---|
| 1 | Untreated | 62.25b |
| 2 | RI | 62.61ab |
| 3 | FST/IST/RI | 64.50a |
| 4 | FST/IST/LCO/RI | 64.07ab |
| 5 | TAMG-SL/FST/IST/RI | 64.18a |
| 6 | TAMG-PT/FST/IST/RI | 63.58ab |

Data were analyzed using an analysis of variance for a randomized complete block design. Estimates were generated and significance declared at P ≦ 0.20.

Data were analyzed using an analysis of variance for a randomized complete block design. Estimates were generated and significance declared at P≦0.20.

A location-based yield analysis revealed that TAMG Treatments 5 and 6 provided statistically comparable yields to the treatment formulated with the commercial rhizobia and LCO (Treatment 4) across locations (Table 15). TAMG treatment yields were also statistically greater than the Untreated Control at the Ames and Ridgeway locations. The largest difference in yield was observed at the Ridgeway location, which was under the greatest stress among the five locations during the 2011 growing season.

TABLE 15
Soybean grain yield response to TAGM seed treatments by location.

| Treatment | | Treatment | Estimated Yield |
|---|---|---|---|
| Number | Location | Description | (BPA) |
| 1 | Ames, IA | Untreated | 55.76b |
| 2 | | RI | 62.22a |
| 3 | | FST/IST/RI | 59.10a |
| 4 | | FST/IST/LCO/RI | 59.78a |
| 5 | | TAMG- | 60.75a |
| | | SL/FST/IST/RI | |
| 6 | | TAMG- | 59.99a |
| | | PT/FST/IST/RI | |
| 1 | Bloomington, IL | Untreated | 69.08ab |
| 2 | | RI | 65.35b |
| 3 | | FST/IST/RI | 69.51a |
| 4 | | FST/IST/LCO/RI | 66.43ab |
| 5 | | TAMG- | 65.85ab |
| | | SL/FST/IST/RI | |
| 6 | | TAMG- | 66.23ab |
| | | PT/FST/IST/RI | |
| 1 | Champaign, IL | Untreated | 62.04a |
| 2 | | RI | 63.82a |
| 3 | | FST/IST/RI | 64.44a |
| 4 | | FST/IST/LCO/RI | 63.78a |
| 5 | | TAMG- | 62.88a |
| | | SL/FST/IST/RI | |
| 6 | | TAMG- | 65.05a |
| | | PT/FST/IST/RI | |
| 1 | Eldora, IA | Untreated | 72.88a |
| 2 | | RI | 70.16ab |
| 3 | | FST/IST/RI | 70.43ab |
| 4 | | FST/IST/LCO/RI | 68.90ab |
| 5 | | TAMG- | 72.12a |
| | | SL/FST/IST/RI | |
| 6 | | TAMG- | 67.12b |
| | | PT/FST/IST/RI | |
| 1 | Ridgeway, IL | Untreated | 51.47b |
| 2 | | RI | 51.51b |
| 3 | | FST/IST/RI | 59.03a |
| 4 | | FST/IST/LCO/RI | 61.46a |
| 5 | | TAMG- | 59.28a |
| | | SL/FST/IST/RI | |
| 6 | | TAMG- | 59.54a |
| | | PT/FST/IST/RI | |

Data were analyzed using an analysis of variance for a randomized complete block design. Estimates were generated and significance declared at P ≦ 0.20.

Data were analyzed using an analysis of variance for a randomized complete block design. Estimates were generated and significance declared at P≦0.20.

### Example 7

### Effect of TAMG on Seed Germination Under Conditions of Cold and Salt Stress

A series of Petri dish seed assays was conducted to evaluate the effects TAMG on the germination rates of corn, soybean, and canola seeds subjected to salt stress, cold stress and non-stressed conditions (salt stress only for canola). Assays were performed with ten replications of ten seeds/plate (100 total seeds). TAMG was applied to seeds at the specified concentrations prior to being placed in Petri dishes. Seeds designated for Salt Stress Experiments 1 & 2 were placed in Petri dishes containing a 100 mM NaCl solution and incubated at 21° C.-22° C. in the dark. Cold stress Petri dishes were incubated at 15° C. in the dark. Untreated Controls were incubated at 21° C.-22° C. in the dark as were seeds utilized in the separately conducted non-stressed germination assays. Data was recorded as percent germination at designated times after plating. Statistical analyses were performed using one-way Anova and Kruskal-Wallis one-way analysis of variance on rank combined with Dunn's all pairwise multiple comparison procedure (α=0.05).

### Results

There was no statistically significant difference in percent germination at selected time points for non-stressed corn seeds. The TAMG treatment did, however, exhibit a directional increase in percent germination at 34 and 44 hours after plating (Table 16).

TABLE 16
Effect of TAMG on Non-Stressed Corn Seed Germination
(% germination hours after plating).

| Treatment | 28 HAP | 34 HAP | 44 HAP |
|---|---|---|---|
| Untreated Control | 31a | 70a | 93a |
| 10⁻⁶M TAMG | 26a | 75a | 100a |

There was no statistically significant difference in percent germination at selected time points for corn seeds in Salt Stress Experiment 1. Both TAMG treatments showed a directional increase in percent germination at all three time points (Table 17).

TABLE 17
Effect of Salt Stress on TAMG Corn Seed Germination (%
germination hours after plating). Experiment 1.

| Treatment | 30 HAP | 40 HAP | 48 HAP |
|---|---|---|---|
| Untreated Control | 25a | 64a | 91a |
| 10⁻⁶M TAMG | 27a | 82a | 94a |
| 10⁻⁷M TAMG | 31a | 78a | 93a |

There was no statistically significant difference in percent germination at selected time points for corn seeds in Salt Stress Experiment 2 (Table 18). Both TAMG treatments exhibited a directional increase in percent germination at 32 and 42 HAP.

TABLE 18
Effect of Salt Stress on TAMG Corn Seed Germination (%
germination hours after plating). Experiment 2.

| Treatment | 32 HAP | 42 HAP |
|---|---|---|
| Untreated Control | 26a | 85a |
| 10⁻⁶M TAMG | 29a | 94a |
| 10⁻⁷M TAMG | 28a | 94a |

There was no statistically significant difference in percent germination at selected time points for corn seeds subjected to cold stress (Table 19). Both TAMG treatments exhibited a directional increase in percent germination at 48 and 56 HAP.

TABLE 19
Effect of Cold Stress on TAMG Corn Seed Germination (%
germination hours after plating).

| Treatment | 48 HAP | 56 HAP | 65 HAP |
|---|---|---|---|
| Untreated Control | 11b | 55a | 100 |
| 10⁻⁶M TAMG | 21ab | 60a | 100 |
| 10⁻⁷M TAMG | 18ab | 63a | 100 |

The 10⁻⁶ M TAMG treatment exhibited a statistically significant increase in percent germination at 34 HAP for soybean seeds subjected to salt stress (Table 20). Both TAMG treatments exhibited a directional increase in percent germination at 45, 55 and 65 HAP.

TABLE 20
Effect of Salt Stress on TAMG Soybean Seed Germination (%
germination hours after plating).

| Treatment | 27 HAP | 34 HAP | 45 HAP | 55 HAP | 65 HAP |
|---|---|---|---|---|---|
| Untreated | 14ab | 51b | 80b | 90a | 94a |
| Control | | | | | |
| 10⁻⁶M | 12ab | 81a | 94ab | 98a | 100a |
| TAMG | | | | | |
| 10⁻⁷M | 11bc | 53b | 84ab | 91a | 99a |
| TAMG | | | | | |

There was no statistically significant difference in percent germination at selected time points for soybean seeds subjected to cold stress (Table 21). Both TAMG treatments exhibited a directional increase in percent germination at 44 HAP.

TABLE 21
Effect of Cold Stress on TAMG Soybean Seed Germination (%
germination hours after plating).

| Treatment | 30 HAP | 36 HAP | 44 HAP | 50 HAP | 60 HAP |
|---|---|---|---|---|---|
| Untreated | 23a | 59a | 73a | 92a | 96a |
| Control | | | | | |
| 10⁻⁶M | 17a | 56a | 90a | 94a | 95a |
| TAMG | | | | | |
| 10⁻⁷M | 25a | 59a | 83a | 91a | 97a |
| TAMG | | | | | |

There was no statistically significant difference in percent germination at selected time points for canola seeds subjected to salt stress (Table 22).

TABLE 22
Effect of Salt Stress on TAMG Canola Seed Germination (%
germination hours after plating).

| Treatment | 30 HAP | 39 HAP | 48 HAP |
|---|---|---|---|
| Untreated Control | 17.3a | 63.4a | 84a |
| 10⁻⁶M TAMG | 21.3a | 68a | 81.3a |
| 10⁻⁷M TAMG | 19.3a | 66.7a | 86.7a |

What is claimed is:

1. A method for accelerating the germination of a plant propagating material, comprising applying to the plant propagating material a compound represented by the general Formula 1, 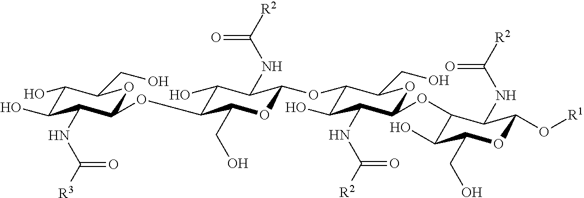
wherein individual groups R¹ and R² are independently selected from: H, C¹ to C²⁰ alkyl, aryl, and alkaryl; and C² to C²⁰ mono, di or polyalkynyl groups; R³ is selected from C¹ to C²⁰ alkyl, aryl, and alkaryl; and C² to C²⁰ mono, di or polyalkynyl groups.

2. The method of claim 1, wherein the compound is applied to a seed.

3. The method of claim 2, wherein the compound is applied to the seed at a concentration of 10⁻⁵ M to 10⁻¹² M.

4. The method of claim 3, wherein the seed is a soybean seed.

5. The method of claim 1, wherein the compound is tetra-N-acyl-beta-D-methyl-glycoside.

6. The method of claim 5, wherein the compound is applied to a seed.

7. The method of claim 6, wherein the compound is applied to a seed at a concentration of 10⁻⁵ M to 10⁻¹² M.

8. The method of claim 7, wherein the seed is a soybean seed.

9. A method for increasing plant yield or vigor, comprising applying a compound to a plant represented by the general Formula 1, 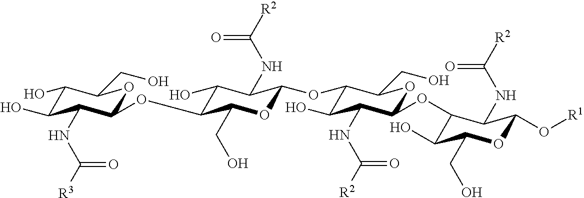
wherein individual groups R¹ and R² are independently selected from: H, C¹ to C²⁰ alkyl, aryl, and alkaryl; and C² to C²⁰ mono, di or polyalkynyl groups; R³ is selected from C¹ to C²⁰ alkyl, aryl, and alkaryl; and C² to C²⁰ mono, di or polyalkynyl groups.

10. The method of claim 9, wherein the compound is tetra-N-acyl-beta-D-methyl-glycoside.

11. The method of claim 10, wherein the compound is applied to a plant propagating material.

12. The method of claim 11, wherein the plant propagating material is potato propagating material.

13. The method of claim 11, wherein the compound is applied to the plant propagating material at a concentration of 10⁻⁵ M to 10⁻¹² M.

14. The method of claim 11, wherein the plant propagating material comprises a seed.

15. The method of claim 14, wherein the seed is a wheat seed.

16. The method of claim 14, wherein the seed is a soybean seed.

17. The method of claim 14, wherein the seed is subject to an abiotic stress.

18. The method of claim 17, wherein the abiotic stress is salt stress.

19. The method of claim 17, wherein the seed is a soybean seed.
